(19) United States
(12) Patent Application Publication
(10) Pub. No.: US 2013/0205012 A1
(43) Pub. Date: Aug. 8, 2013

(54) APPARATUS AND METHOD FOR TRANSMITTING NODE DISCOVERY MESSAGES

(71) Applicants: Soo-Hyung LEE, Daejeon (KR); Jae-Hyuk KIM, Gunpo-si (KR); Hyung-Kook JUN, Seoul (KR); Kyung-Il KIM, Daejeon (KR); Kyeong-Tae KIM, Daejeon (KR); Yong-Yeon KIM, Daejeon (KR)

(72) Inventors: Soo-Hyung LEE, Daejeon (KR); Jae-Hyuk KIM, Gunpo-si (KR); Hyung-Kook JUN, Seoul (KR); Kyung-Il KIM, Daejeon (KR); Kyeong-Tae KIM, Daejeon (KR); Yong-Yeon KIM, Daejeon (KR)

(73) Assignee: Electronics Telecommunications Research Institute, Daejeon (KR)

(21) Appl. No.: 13/614,246

(22) Filed: Sep. 13, 2012

(30) Foreign Application Priority Data
Feb. 7, 2012 (KR) 10-2012-0012367

(51) Int. Cl. G06F 15/173

(52) U.S. Cl. 709/224

(57) ABSTRACT

Disclosed herein are an apparatus and method for transmitting Node Discovery Messages. The apparatus includes a Medium Access Control layer information collection unit, a Discovery Window Slot calculation unit, a DW size determination unit, a DWS selection unit, and an NDM processing unit. The MAC layer information collection unit collects time slot information for NDMs in a previous round. The DWS calculation unit generates information about the slots of a Discovery Window of a discovery frame in the previous round based on the time slot information. The DW size determination unit determines the size of the DW in a current round based on the information about the slots of the DW. The DWS selection unit selects Discovery Window Slots in the current round based on the size of the DW. The NDM processing unit sends the NDMs during respective times corresponding to the DWSs.

### CROSS REFERENCE TO RELATED APPLICATION

This application claims the benefit of Korean Patent Application No. 10-2012-0012367, filed on Feb. 7, 2012, which is hereby incorporated by reference in its entirety into this application.

### BACKGROUND OF THE INVENTION

1. Technical Field

The present invention relates generally to an apparatus and method by which communication nodes send Node Discovery Messages (NDMs) and, more particularly, to an apparatus and method for scheduling a sequence in which NDMs are transmitted by a plurality of communication nodes so that the plurality of communication nodes may effectively exchange the NDMs adapted to set up connections in a network environment in which the plurality of communication nodes shares a transmission medium.

2. Description of the Related Art

Today, in technology for searching for communication nodes, when a request for the discovery of communication nodes is made using multicasting if each communication node has previously detected a group of other communication nodes with which a service or data will be exchanged, or using broadcasting if not, entities at the communication nodes respond to the request, and thus data is exchanged or a service is provided.

In order to set up communication connections, when each communication node directly detects entities at communication nodes, that is, connection targets, and manages information about connections with the communication nodes, the communication node may directly set up the communication connections only on the basis of the connection information. With a recent sudden increase in the number of communication entities that constitute an entire application and also a sudden increase in the number of types of data and the number of provided services, it has become very difficult for each communication node to manage information about connections with entities at communication nodes, that is, connection targets. Furthermore, since the content of data and the content of a service to be provided to or to be requested by each communication node may change depending on the situation, it has become practically impossible for the communication node to previously set and manage information about the entities at counterpart communication nodes that are to be connected to.

In order to overcome the problems, U.S. Pat. No. 7,330,882 discloses a method of detecting an entity at a communication node from which data or a service will be requested or provided at the time at which the data or service actually needs to be requested/provided and discovering information about a connection with the entity.

In the method of discovering a communication entity, information about a connection with the communication entity must be found in the state in which the communication entity has not been recognized. Accordingly, there is used a method of placing a server at the center, registering information about data or a service, to be provided or requested, with the server, and obtaining information about a connection with a counterpart communication entity by searching for the data and service information, or a method of requesting information related to a communication connection from non-specific communication entities making up the entire application, using multicasting or broadcasting and receiving a response thereto.

If a server is placed at the center as in the former method, a disadvantage arises in that it is difficult to run the entire application when the server is not operating properly. The latter method is disadvantageous in that it is difficult to use the latter method if a network that will connect communication entities making up the entire application does not support broadcasting or multicasting even though the erroneous operation of a specific node rarely influences the entire application because distributed processing is possible.

Furthermore, in a complex system in which the number of communication nodes is equal to or larger than a specific value and the communication nodes are located close to each other, if the communication nodes multicast or broadcast NDMs at the same time, a problem arises in that the overload imposed on a network occurs in a network environment in which a transmission medium is shared, thereby making it impossible to exchange NDMs between the communication nodes.

### SUMMARY OF THE INVENTION

Accordingly, the present invention has been made keeping in mind the above problems occurring in the prior art, and an object of the present invention is to provide a technology in which communication nodes requiring interactions in a complex system including many physical nodes can schedule the transmission of NDMs in a distributed and independent manner so that the communication nodes can efficiently exchange required NDMs when setting up mutual connections.

In order to accomplish the above object, the present invention provides an apparatus for transmitting Node Discovery Messages (NDMs), including a Medium Access Control (MAC) layer information collection unit for collecting time slot information for NDMs in a previous round from an MAC layer; a Discovery Window Slot (DWS) calculation unit for generating information about slots of a Discovery Window (DW) of a discovery frame in the previous round based on the time slot information; a DW size determination unit for determining a size of the DW in a current round based on the information about the slots of the DW; a DWS selection unit for selecting Discovery Window Slots (DWSs) for allocation of NDMs to be sent in the current round based on the size of the DW; and an NDM processing unit for sending the NDMs during respective times corresponding to the DWSs.

The discovery frame may include a message indicating the start of the discovery frame, the DW including the NDMs of respective communication nodes participating in discovery, a message indicating the size of the DW, and a message indicating the end of the discovery frame.

The time slot information for NDMs in the previous round may include the number of successfully transmitted NDMs, the number of collided NDMs and the number of idle time slots for NDMs in the previous round; and the information about the slots of the DW of the discovery frame in the previous round may include the number of successfully transmitted NDMs, the number of collided NDMs and the number of idle DWSs for the discovery frame in the previous round.

The DW size determination unit may estimate the number of communication nodes participating in discovery in the previous round based on the number of successfully transmitted NDMs, the number of collided NDMs, and the number of idle time slots in the previous round and an error in a distribution function for allocation of the NDMs to the slots of the DW.

The DW size determination unit may determine the size of the DW in the current round by calculating the number of communication nodes, which attempt to participate in discovery in the current round, using a difference between the number of communication nodes participating in discovery in the previous round and the number of successful DWSs in the previous round.

The MAC layer information collection unit may collect the time slot information for NDMs in the previous round from Management Information Base (MIB) information of the MAC layer.

The DWS selection unit may select slots of the DW for allocation of the NDMs to be sent in the current round based on an identical distribution function for all communication nodes.

The distribution function may be a hash function or a random number function.

In order to accomplish the above object, the present invention provides a method of transmitting NDMs, including collecting time slot information for NDMs in a previous round from a MAC layer; generating information about slots of a DW of a discovery frame in the previous round based on the time slot information; determining a size of the DW in a current round based on the information about the slots of the DW; selecting DWSs for allocation of NDMs to be sent in the current round based on the size of the DW; and sending the NDMs during respective times corresponding to the DWSs.

The discovery frame may include a message indicating the start of the discovery frame, the DW including the NDMs of respective communication nodes participating in discovery, a message indicating the size of the DW, and a message indicating the end of the discovery frame.

The time slot information for NDMs in the previous round may include the number of successfully transmitted NDMs, the number of collided NDMs and the number of idle time slots for NDMs in the previous round; and the information about the slots of the DW of the discovery frame in the previous round may include the number of successfully transmitted NDMs, the number of collided NDMs and the number of idle DWSs for the discovery frame in the previous round.

The determining the size of the DW in the current round may include estimating the number of communication nodes participating in discovery in the previous round based on the number of successfully transmitted NDMs, the number of collided NDMs and the number of idle time slots in the previous round and an error in a distribution function for allocation of the NDMs to the slots of the DW.

The determining the size of the DW in the current round may include determining the size of the DW in the current round by calculating the number of communication nodes, attempting to participate in discovery in the current round, using a difference between the number of communication nodes participating in discovery in the previous round and the number of successful DWSs in the previous round.

The time slot information for NDMs in the previous round may be collected from MIB information of the MAC layer.

The selecting the DWSs may include selecting the size of the DW for allocation of the NDMs to be sent in the current round based on an identical distribution function for all communication nodes.

The distribution function may be a hash function or a random number function.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating the structure of a discovery frame for scheduling NDMs according to the present invention;

FIG. 2 is a diagram showing the configuration of an apparatus by which communication nodes transmit NDMs according to the present invention;

FIG. 3 is a diagram illustrating an embodiment in which communication nodes send NDMs using the apparatus for transmitting NDMs according to the present invention; and

FIGS. 4 and 5 are flowcharts illustrating a method by which communication nodes transmit NDMs according to the present invention.

### DESCRIPTION OF THE PREFERRED EMBODIMENTS

The present invention will be described below in detail with reference to the accompanying drawings below. Here, repetitive descriptions, and detailed descriptions of well-known functions or configurations which would unnecessarily obscure the gist of the present invention will be omitted. Embodiments of the present invention are provided to complete the explanation for those skilled in the art of the present invention. Therefore, the shapes and sizes of components in the drawings may be exaggerated to provide more precise descriptions.

Collisions occur between the NDMs of communication nodes over a network because the communication nodes randomly send the NDMs in order to search for other communication nodes, that is, connection targets, and networks share a transmission medium. When a collision occurs between the NDMs, each communication node randomly selects a time within a Contention Window (CW) within a specific range and attempts retransmission after waiting (backing-off) for a period corresponding to the time. Furthermore, each of the communication nodes increases the value of the CW up to a preset maximum range whenever a collision occurs between the communication messages. Here, if the number of communication nodes is much larger than the maximum value of the CW, the probability that a collision may occur between the communication messages increases, and thus the time that it takes for all the communication nodes to fully exchange NDMs sharply increases. In particular, if the total number of communication nodes exceeds a specific range, the probability that a collision may occur between the communication messages increases in geometrical progression, with the result that each of the communication nodes is unable to send the NDM.

In the present invention, the sequence of transmission of NDMs for communication nodes is scheduled in a higher network layer, such as a middleware layer, so that the total NDM exchange time may be reduced by lowering the possibility of a collision occurring between NDMs in the Medium Access Control (MAC) layer of a network. For this purpose, in the present invention, a logical discovery frame formed of NDMs to be sent by each communication node according to the scheduled sequence is used.

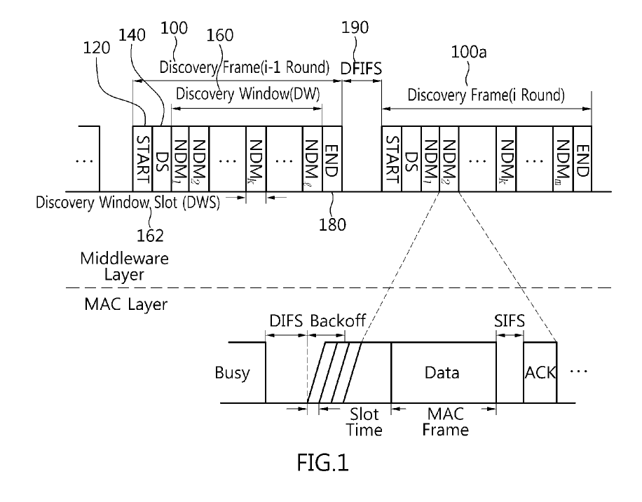

FIG. 1 is a diagram illustrating the structure of a discovery frame 100 for scheduling NDMs according to the present invention.

Referring to FIG. 1, the discovery frame 100 according to the present invention includes a message 120 indicating the start of the frame, a message 140 indicating the size of a Discovery Window (DW) 160 in a corresponding round, the DW 160 including a plurality of slots to which NDMs to be sent by respective communication nodes are allocated, and a message 180 indicating the end of the frame. Furthermore, discovery frames 100 and 100a corresponding to respective rounds are spaced apart from each other at a specific interval which is represented by a Discovery Frame's Inter-Frame Spaces (DFIFSs) 190. Here, in order to send their NDMs in a specific round, respective communication nodes determine Discovery Window Slots (DWSs) for the allocation of the NDMs using the same distribution function. If the NDMs are allocated to the DWSs based on an ideal distribution function, a single NDM can be allocated to each of the DWSs. However, since the distribution function cannot be ideal in practice, errors occur when the NDMs are allocated. Accordingly, there may be a collision DWS because a collision occurs between a plurality of NDMs due to the allocation of two or more NDMs to one DWS in the DW 160, and there may be an idle DWS to which no NDM has been allocated. In the present invention, the size of the DW 160, that is, the number of DWSs, is dynamically determined in each round using the successfully transmitted NDMs, collided NDMs, and idle DWSs in a previous round. Accordingly, the discovery frame 100 is reconfigured in each round until all communication nodes have been discovered.

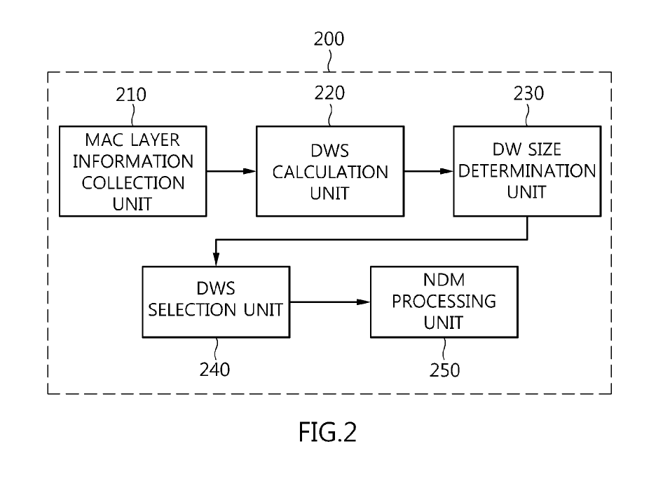

FIG. 2 is a diagram showing the configuration of an apparatus by which communication nodes transmit NDMs according to the present invention.

Referring to FIG. 2, the apparatus by which communication nodes transmit NDMs 200 according to the present invention includes an MAC layer information collection unit 210 for collecting MAC Frame (MACF) information transmitted by an MAC layer over a network, a DWS calculation unit 220 for generating information about the DWSs of a discovery frame in a previous round ((i−1)-th round) based on the collected MACF information, a DW size determination unit 230 for determining the size of a DW in a current round (i-th round) based on the generated information about the DWSs of the discovery frame, a DWS selection unit 240 for selecting DWSs of the discovery frame to which NDMs are to be sent in the current round, and an NDM processing unit 250 for sending the NDMs during respective times corresponding to the selected DWSs of the discovery frame.

The MAC layer information collection unit 210 collects time slot information for NDMs in the previous round ((i−1)-th round) in which the NDMs were transmitted, that is, a round immediately before the current round (i-th round) in which NDMs will be transmitted, from the MAC layer. Here, the time slot information for NDMs in the previous round, which is collected by the MAC layer information collection unit 210, includes the number of successful time slots, the number of collision time slots in which collisions took place, and the number of idle time slots in the previous round. Here, the MAC layer information collection unit 210 may collect time slot information for NDMs in the previous round from the Management Information Base (MIB) information of the MAC layer. The MAC layer information collection unit 210 sends the time slot information for NDMs in the previous round, collected from the MAC layer, to the DWS calculation unit 220.

The DWS calculation unit 220 generates information about the slots of the DW of the discovery frame in the previous round from the time slot information for NDMs in the previous round which has been received from the MAC layer information collection unit 210. More particularly, the DWS calculation unit 220 calculates the number of successful DWSs, the number of collision DWSs and the number of idle DWSs for the NDMs of the discovery frame in the previous round using information about the number of successful time slots, the number of collision time slots and the number of idle time slots for NDMs in the previous round, which has been received from the MAC layer information collection unit 210. Here, the number of DWSs for each type may be calculated based on the number of time slots for each type because the NDMs of each communication node have the same size in accordance with a protocol used.

The DW size determination unit 230 determines the size of a DW in the current round using information about the slots of the DW of the discovery frame in the previous round, which has been generated by the DWS calculation unit 220. If a distribution function required for each communication node to select DWSs within a DW is ideal, the communication node selects uniform DWSs within the DW. However, every distribution function generates an error. If this error is used, the number of communication nodes participating in discovery in the previous round may be represented by a function of the size of the DW, the number of successful DWSs and the number of idle DWSs in the previous round. More particularly, since distribution functions which are used by respective communication nodes to select DWSs within a DW are not ideal and the respective communication nodes select DWSs using independent distribution functions, there may be a collision DWS and an idle DWS because of the error in the distribution functions used by the communication nodes to select the same DWS in a specific round. If the number of communication nodes N_{R}ⁱ⁻¹ participating in discovery in the previous round may be represented by a linear function, such as that shown in the following Equation 1, the influence of the errors of distribution functions may be represented by the following Equation 2:

N_{R}ⁱ⁻¹=a·DWⁱ⁻¹+b (1)

N_{R}ⁱ⁻¹·ε=(a−1)·DWS_{T}ⁱ⁻¹+a·DWS_{E}ⁱ⁻¹,DWS_{T}ⁱ⁻¹>0 (2)

where N_{R}ⁱ⁻¹ is the size of the DW in the previous round, DWS_{T}ⁱ⁻¹ is the number of successful DWSs in the previous round, and DWS_{E}ⁱ⁻¹ is the number of idle DWSs in the previous round.

If the expectation value E(b) of b according to Equations 1 and 2 and the following Equation 3 is used, the number of communication nodes N_{R}ⁱ⁻¹ participating in discovery in the previous round may be estimated using the following Equation 4:

$$\begin{matrix}E ( b ) = \frac{{DWS}_{C}^{i - 1}}{2} & ( 3 ) \\ {N}_{R}^{i - 1} = ( {DWS}_{T}^{i - 1} + K ) / ( \frac{{DWS}_{T}^{i - 1}}{{DW}^{i - 1}} + \frac{{DWS}_{E}^{i - 1}}{{DW}^{i - 1}} - ɛ ) , \\ K = \frac{{DWS}_{C}^{i - 1}}{2 \cdot {DW}^{i - 1}} \cdot ( {DWS}_{T}^{i - 1} + {DWS}_{E}^{i - 1} ) & ( 4 )\end{matrix}$$

where DWS_{C}ⁱ⁻¹ is the number of collision DWSs in the previous round.

Next, the number of communication nodes N_{R}ⁱ which attempt to participate in discovery in the current round is calculated using the following Equation 5, and the size of the DW DWⁱ in the current round is determined based on the number of communication nodes N_{R}ⁱ:

N_{R}ⁱ=N_{R}ⁱ−DWS_{T}ⁱ⁻¹ (5)

where the number of communication nodes N_{R}ⁱ which attempt to participate in discovery in the current round may become the number of DWSs in the current round, that is, the size of the DW DWⁱ.

When the size of the DW in the current round is determined by the DW size determination unit 230, the DWS selection unit 240 selects DWSs to which NDMs are to be sent in the current round based on the size of the DW in the current round. Here, all the communication nodes determine DWSs to be used using the same distribution function. A hash function or a random number function may be used as the distribution function.

When the DWSs to which the NDMs are to be sent in the current round are selected by the DWS selection unit 240, the NDM processing unit 250 configures actual NDMs and sends the NDMs during scheduled times corresponding to the selected DWSs. That is, when a time window slot to be used is determined, each communication node waits until the corresponding time has been reached, and sends its NDM via the NDM processing unit 250.

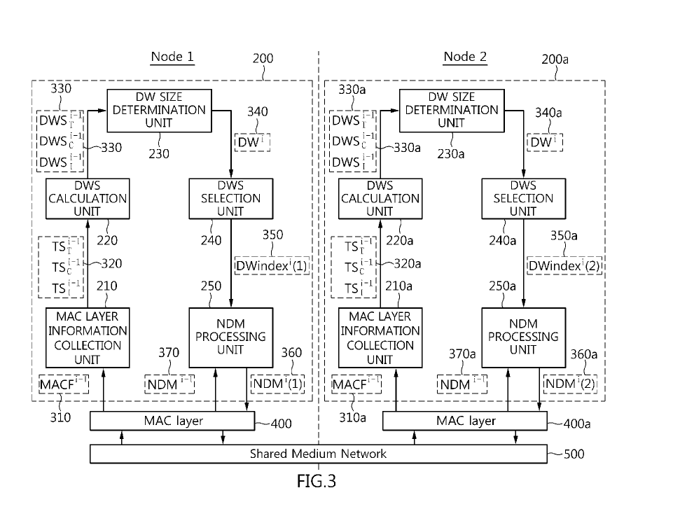

FIG. 3 is a diagram illustrating an embodiment in which communication nodes send NDMs using the apparatus for transmitting NDMs according to the present invention. In FIG. 3, only two communication nodes Node 1 and Node 2 are shown for convenience of description, but the present embodiment may also be applied to other communication nodes which are not shown.

Referring to FIG. 3, in each of the communication nodes Node 1 and Node 2, the MAC layer information collection unit 210 or 210a collects all MACF information 310 or 310a transmitted by an MAC layer 400 or 400a over a network and sends information 320 or 320a about the number of successful DWSs, the number of collision DWSs and the number of idle DWSs in a previous round to the DWS calculation unit 220 or 220a. The DWS calculation unit 220 or 220a calculates the number of successful DWSs, the number of collision DWSs and the number of idle DWSs in the previous round 330 or 330a based on the information 320 or 320a about the number of successful DWSs, the number of collision DWSs and the number of idle DWSs in the previous round, and sends them to the DW size determination unit 230 or 230a. The DW size determination unit 230 or 230a determines the size of a DW 340 or 340a in a current round using the number of successful DWSs, the number of collision DWSs and the number of idle DWSs in the previous round 330 or 330a and an error in the distribution function, and sends the size of the DW 340 or 340a to the DWS selection unit 240 or 240a. The DWS selection unit 240 or 240a selects DWSs to which NDMs to be sent in the current round will be allocated based on the size of the DW 340 or 340a in the current round, and sends information 350 or 350a about the selected DWSs to the NDM processing unit 250 or 250a. The NDM processing unit 250 or 250a waits until the scheduled times have been reached based on the information 350 or 350a about the selected DWSs, and sends the NDM of a communication node to which the NDM processing unit 250 or 250a belongs over a network 500 using the MAC layer 400 or 400a. Meanwhile, the NDM processing unit 250 or 250a may process NDMs 370 or 370a from other communication nodes which have been received via the MAC layer 400 or 400a. The communication nodes Node 1 and Node 2 may independently determine the sizes of DWs and select DWSs to which NDMs will be allocated based on respective pieces of information about the same number of time slots collected via the respective MAC layers 400 and 400a.

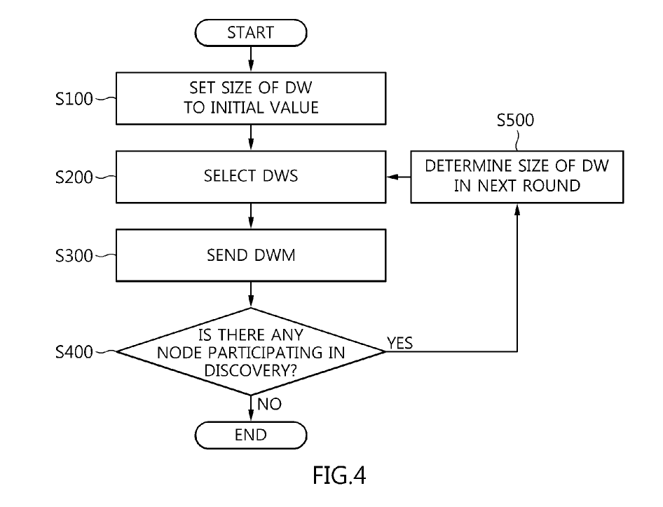

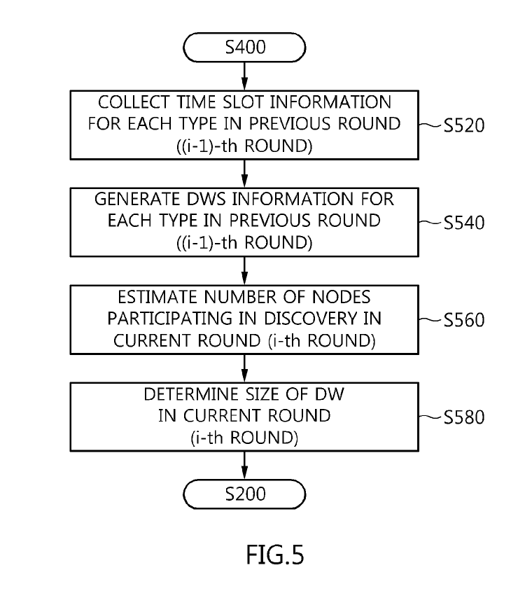

A method by which communication nodes send NDMs using a discovery frame according to the present invention is described below with reference to FIGS. 4 and 5. Descriptions of the parts of the operation that are the same as those of the operation of the apparatus for transmitting NDMs according to the present invention, described with reference to FIGS. 1 to 3, will be omitted.

FIG. 4 is a flowchart illustrating a method by which communication nodes send NDMs using a discovery frame according to the present invention.

Referring to FIG. 4, in the method of transmitting NDMs according to the present invention, if a round in which NDMs are sent is a first round, the DW size determination unit 230 of the communication node sets the size of a DW to an initial value DW¹ and then sends the size of the DW to the DWS selection unit 240 because there is no information about the transmission status of NDMs in a previous round at step S100.

The DWS selection unit 240 selects DWSs to which the NDMs will be allocated according to a distribution function based on the size of the DW received from the DW size determination unit 230 and sends information about the selected DWSs to the NDM processing unit 250 at step S200.

Thereafter, the NDM processing unit 250 configures NDM and sends the configured NDM over a network via the MAC layer based on the received information about the DWS during scheduled times at step S300.

When all communication nodes exchange the NDMs between themselves in a corresponding round, whether there is any communication node attempting to participate in discovery is determined at step S400.

If, as a result of the determination at step S400, it is determined that there is no communication node attempting to participate in discovery, the transmission of the NDMs of the communication nodes is terminated.

If, as a result of the determination at step S400, it is determined that there is a communication node attempting to participate in discovery because of a collision generated in the transmission of NDMs, in order to proceed to a subsequent round for exchanging the NDMs, the DW size determination unit 230 determines the size of a DW for scheduling the transmission of the NDMs and sends the size of the DW to the DWS selection unit 240 at step S500. Steps S200 to S500 are repeatedly performed until there are no more communication nodes attempting to participate in discovery.

FIG. 5 shows a detailed flowchart of step S500 in the method of transmitting NDMs according to the present invention.

Referring to FIG. 5, at step S500 of determining the size of the DW, first, the MAC layer information collection unit 210 collects information about the number of successful DWSs, the number of collision time slots and the number of idle DWSs for NDMs, that is, information about the number of time slots for each type in a previous round from the MAC layer at step S520.

Thereafter, the DWS calculation unit 220 generates information about the slots of the DW of a discovery frame in the previous round based on the information about the number of time slots for each type in the previous round at step S540. Here, the generated information about the slots of the DW of the discovery frame in the previous round includes the number of successful DWSs, the number of collision DWSs and the number of idle DWSs for NDMs in the previous round which are calculated based on the number of successful time slots, the number of collision time slots and the number of idle time slots for NDMs.

Thereafter, the DW size determination unit 230 estimates the number of communication nodes attempting to participate in discovery in a current round based on the number of successful DWSs, the number of collision DWSs and the number of idle DWSs for NDMs in the previous round, calculated by the DWS calculation unit 220, and error information in the distribution function at step S560, calculates the number of communication nodes attempting to participate in discovery in the current round, that is, a difference between the estimated number of communication nodes attempting to participate in discovery in the current round and the number of successful DWSs for NDMs in the previous round, and determines the size of the DW in the current round based on the calculation at step S580.

In accordance with the present invention, each communication node may independently determine the number of communication nodes attempting to participate in discovery in a current round, that is, the size of a DW, and independently select a DWS to which its NDM is to be sent based only on information about the number of time slots for each type and information about the size of a DW in a previous round, which are provided via its own MAC layer without exchanging connection information.

In accordance with the present invention, an advantage arises in that a plurality of communication nodes may efficiently exchange NDMs even when they are coupled over a network in which the communication nodes share a transmission medium because of scheduling the sequence of transmission of the NDMs for discovery between the communication nodes in a higher network layer.

Furthermore, in accordance with the present invention, an advantage arises in that each communication node may independently determine the schedule of transmission of NDMs to be sent without requiring interaction with other communication nodes because it may independently obtain information necessary to schedule the sequence of transmission of the NDMs.

Moreover, in accordance with the present invention, an advantage arises in that a sharp increase in the total number of rounds necessary to exchange NDMs can be prevented by variably increasing the size of a discovery frame for scheduling the sequence of transmission of the NDMs in each round in response to an increase in the number of communication nodes sharing a transmission medium even though the number of communication nodes increases.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for transmitting Node Discovery Messages (NDMs), comprising:
a Medium Access Control (MAC) layer information collection unit for collecting time slot information for NDMs in a previous round from an MAC layer;
a Discovery Window Slot (DWS) calculation unit for generating information about slots of a Discovery Window (DW) of a discovery frame in the previous round based on the time slot information;
a DW size determination unit for determining a size of the DW in a current round based on the information about the slots of the DW;
a DWS selection unit for selecting Discovery Window Slots (DWSs) for allocation of NDMs to be sent in the current round based on the size of the DW; and
an NDM processing unit for sending the NDMs during respective times corresponding to the DWSs.

2. The apparatus of claim 1, wherein the discovery frame comprises a message indicating a start of the discovery frame, the DW including the NDMs of respective communication nodes participating in discovery, a message indicating the size of the DW, and a message indicating an end of the discovery frame.

3. The apparatus of claim 1, wherein:
the time slot information for NDMs in the previous round comprises a number of successfully transmitted NDMs, a number of collided NDMs, and a number of idle time slots in the previous round; and
the information about the slots of the DW of the discovery frame in the previous round comprises a number of successfully transmitted NDMs, a number of collided NDMs and a number of idle DWSs for the discovery frame in the previous round.

4. The apparatus of claim 3, wherein the DW size determination unit estimates a number of communication nodes participating in discovery in the previous round based on the number of successfully transmitted NDMs, the number of collided NDMs and the number of idle time slots for NDMs in the previous round and an error in a distribution function for allocation of the NDMs to the slots of the DW.

5. The apparatus of claim 4, wherein the DW size determination unit determines the size of the DW in the current round by calculating a number of communication nodes, which attempt to participate in discovery in the current round, using a difference between the number of communication nodes participating in discovery in the previous round and a number of successful DWSs in the previous round.

6. The apparatus of claim 1, wherein the MAC layer information collection unit collects the time slot information for NDMs in the previous round from Management Information Base (MIB) information of the MAC layer.

7. The apparatus of claim 1, wherein the DWS selection unit selects slots of the DW for allocation of the NDMs to be sent in the current round based on an identical distribution function for all communication nodes.

8. The apparatus of claim 7, wherein the distribution function is a hash function or a random number function.

9. A method of transmitting NDMs, comprising:
collecting time slot information for NDMs in a previous round from a MAC layer;
generating information about slots of a DW of a discovery frame in the previous round based on the time slot information;
determining a size of the DW in a current round based on the information about the slots of the DW;
selecting DWSs for allocation of NDMs to be sent in the current round based on the size of the DW; and
sending the NDMs during respective times corresponding to the DWSs.

10. The method of claim 9, wherein the discovery frame comprises a message indicating a start of the discovery frame, the DW including the NDMs of respective communication nodes participating in discovery, a message indicating the size of the DW, and a message indicating an end of the discovery frame.

11. The method of claim 9, wherein:
the time slot information for NDMs in the previous round comprises a number of successfully transmitted NDMs, a number of collided NDMs and a number of idle time slots for NDMs in the previous round; and
the information about the slots of the DW of the discovery frame in the previous round comprises a number of successfully transmitted NDMs, a number of collided NDMs and a number of idle DWSs for the discovery frame in the previous round.

12. The method of claim 11, wherein the determining the size of the DW in the current round comprises estimating a number of communication nodes participating in discovery in the previous round based on the number of successfully transmitted NDMs, the number of collided NDMs, and the number of idle time slots in the previous round and an error in a distribution function for allocation of the NDMs to the slots of the DW.

13. The method of claim 12, wherein the determining the size of the DW in the current round comprises determining the size of the DW in the current round by calculating a number of communication nodes, attempting to participate in discovery in the current round, using a difference between the number of communication nodes participating in discovery in the previous round and the number of successful DWSs in the previous round.

14. The method of claim 9, wherein the time slot information for NDMs in the previous round is collected from MIB information of the MAC layer.

15. The method of claim 9, wherein the selecting the DWSs comprises selecting the size of the DW for allocation of the NDMs to be sent in the current round based on an identical distribution function for all communication nodes.

16. The method of claim 15, wherein the distribution function is a hash function or a random number function.
